(19) United States
(12) Patent Application Publication
(10) Pub. No.: US 2012/0059582 A1
(43) Pub. Date: Mar. 8, 2012

(54) SYSTEM AND METHOD OF LOCATING A STRUCTURE IN LARGE SPACES

(76) Inventor: ISAAC S. DANIEL, Miramar, FL (US)

(21) Appl. No.: 12/954,457

(22) Filed: Nov. 24, 2010

Related U.S. Application Data
(63) Continuation-in-part of application No. 12/456,311, filed on Jun. 15, 2009.
Application No. 12/456,311 is a continuation-in-part of application No. 12/462,992, filed on Aug. 12, 2009.
(60) Provisional application No. 61/264,593, filed on Nov. 25, 2009.

(51) Int. Cl. G01C 21/00

(52) U.S. Cl. 701/483

(57) ABSTRACT

The present disclosure relates generally to electronic systems, and more particularly, to systems, methods, and various other disclosures related to locating a structure in large spaces.

### PRIORITY CLAIM

This patent application is a continuation in part of, and claims priority to: United States Non-Provisional patent application Ser. No. 12/456,311 titled: “A Unified Address Enhanced Locator System and Method” filed Jun. 15, 2009; United States Non-Provisional Continuation In Part patent application Ser. No. 12/462,992 titled: “Unified Address Enhanced Locator System And Method For Providing User Information” filed on Aug. 11, 2009; and U.S. Provisional Patent Application Ser. No. 61/264,593 titled: “System and Method of Locating A Structure in Large Spaces” filed Nov. 25, 2009. The entire disclosures of the afore-mentioned patent applications are incorporated by reference as if fully stated herein.

### FIELD OF THE INVENTION

The present disclosure relates generally to electronic systems, and more particularly, to systems, methods, and various other disclosures related to locating a structure in large spaces.

### BACKGROUND OF THE INVENTION

Shopping malls are ideally designed with anchor stores positioned at strategic locations to direct users to visit an area of the mall that they may not otherwise visit, but for the presence of the anchor store. The expectation is that users will make additional purchases in stores located en route to/from the anchor store. In this business model, a non-anchor store is therefore heavily dependent on the sales traffic to the proximal anchor store. However, in multi-storied mega malls, this business model fails as too often the non-anchor stores cannot be readily located as tired, frustrated users will choose to forego searching for a particular store or item.

Shopping malls attempt to mitigate the issue by placing location maps at various locations throughout the malls. However, many users are directionally challenged and/or have difficulty transposing the visual location information from the location maps to their immediate surroundings. As such the users remain lost and/or unable to locate their destination. Thus there is a need for users to have a simple system and method of locating indoor structures that is easy to use where the location information is readily understood by the general public.

The prior art teaches a navigation system for navigating in open spaces, where a user's location is determined based on a location determining device in direct contact with a satellite network system. However, once the location determining device loses its sky view, e.g. entering a tunnel or an enclosed structure, the signal is compromised and the navigational system becomes non-functional. Thus, there is a need for a navigational system that remains operable in enclosed spaces, or areas that lack a sky view that is independent of a satellite signal for determining location.

Accordingly, the various embodiments and disclosures described herein satisfies these long felt needs and solves the limitations of the prior art in a new and novel manner.

### SUMMARY

The systems and methods described herein disclose a system and method comprising of: providing at least one communications means configured to receive at least one signal from a positioning system; providing at least one computer processor configured to determine geographical location of a mobile device by using the at least one computer processor to triangulate the mobile device's geographical location based on the at least one positioning system signal; and generating directions to/from a structure based on the geographical location of the mobile device. System and method further comprise of publishing the directions to the mobile device, wherein the directions may be published in any one or more of the following formats: audio, text or graphical. In this manner, once the structure is located the directions may be published in a map, audibly or by text with step by step instructions.

Communications means includes a radio frequency transceiver, configured to communicate wirelessly over a wireless area network. Communications means is also configured to receive the at least one signal from a positioning system over a wireless area network.

System and method also includes a mobile device which comprises of at least one positioning system receiver, wherein the positioning system receiver is a global positioning system receiver which includes but is not limited to: a positioning system receiver, such as a global positioning system receiver and a local positioning system receiver, such as a wi-fi positioning system receiver.

The processing unit is operative to communicate using a short range wireless protocol, wherein the short range wireless protocol includes any one or more of the following: WiHLoN™, Bluetooth®, ZigBee, and 802.11 series.

According to one embodiment, the systems and methods described herein disclose a system and method for locating a structure in large spaces using preloaded maps featuring detailed directions to any structure within an enclosed space that will allow a user to “search and find” any structure within a large enclosed space. In that embodiment, a requestor may input a starting location and a final destination; or perform a keyword search and the systems and methods described herein will locate the exact structure.

In another embodiment, the systems and methods described herein includes maps customized to a specific venue or vicinity, either indoors or out, wherein the systems and methods are applicable to a wide variety of personal and business uses that range from simple to elaborate, involving complex maps, points of interest, and even suggestions of best routes and methods of reaching a destination.

The systems and methods described herein may be used for indoor large spaces, e.g. indoor shopping malls, convention centers, hospitals, hotels, theatres, museums, airports and even parking garages, to name a few. The systems and methods could also be used in large outdoor areas such as theme parks, transportation systems, sports arenas, parking lots, communities and the service sector. Accordingly, the various embodiments and disclosures described herein solve the limitations of the prior art in a new and novel manner.

Additional objectives of the present invention will appear as the description proceeds.

The foregoing and other objects and advantages will appear from the description to follow. In the description, references are made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views. The following detailed description is, therefore, not to be taken in a limiting sense, and the scope of the present invention is best defined by the appended claims.

### BRIEF DESCRIPTION OF THE DRAWINGS

Further objectives and advantages of the present invention may be derived by referring to the detailed description and claims when considered in connection with the Figures, wherein like reference numbers refer to similar items throughout the Figures.

FIG. 1A & 1B are diagrams illustrative of exemplary embodiments of the system of the invention.

FIG. 2 is an exemplary embodiment of the mobile device of the system of the invention according to one embodiment.

FIG. 3 shows a flowchart of an exemplary method 300 in accordance with one embodiment.

FIGS. 4A & 4B shows an exemplary method block diagram depicting an alternate method in accordance with various embodiments.

FIG. 5 is a block diagram representing an apparatus according to various embodiments.

### DETAILED DESCRIPTION OF PREFERRED EMBODIMENTS

### System Level Overview

The following discussion describes in detail an embodiment of the system and methods for related to locating a structure in large spaces. However, this discussion should not be construed, as limiting the invention to those particular embodiments, as practitioners skilled in the art will appreciate that a system may vary as to configuration and as to details of the parts, and that a method may vary as to the specific steps and sequence, without departing from the basic concepts as disclosed herein. Similarly, the elements described herein may be implemented separately, or in various combinations without departing from the teachings of the present invention. Turning now descriptively to the drawings, in which similar reference characters denote similar elements throughout the several views.

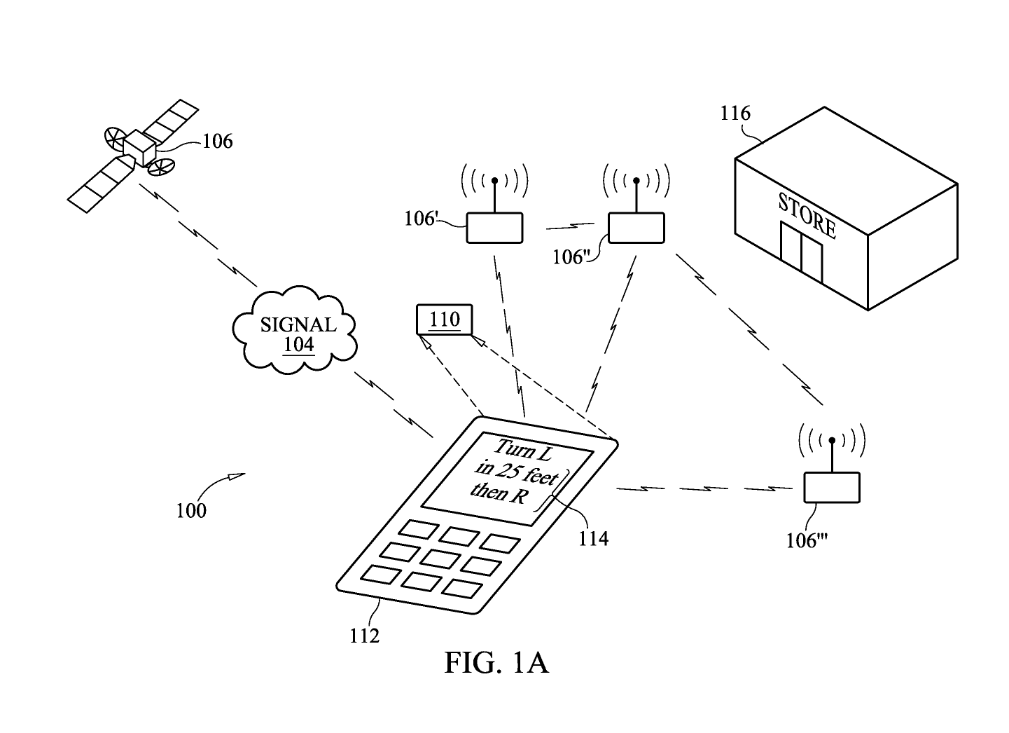

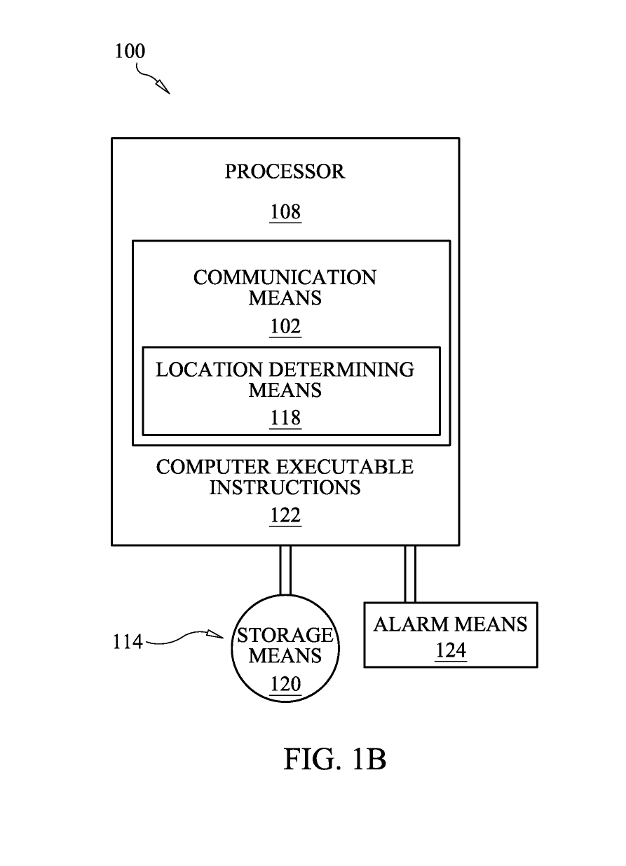

FIGS. 1A & 1B are diagrams illustrative of exemplary embodiments of the system 100 of the invention. System 100 comprises of at least one communications means 102 configured to receive at least one signal 104 from a positioning system 106; and at least one computer processor 108 configured to determine geographical location 110 of a mobile device 112 by using the at least one processor 108 to triangulate the mobile device's geographical location 110 based on the at least one positioning system's signal 104 and wherein the at least one computer processor 108 is configured for generating directions 114 to or from a structure 116 based on the geographical location 110 of the mobile device 112.

Referring to FIG. 1B, communication means 102 include location determining means 118. Communication means 102 may be either electrically or mechanically connected to the computer processor 108. In the case of electronic connections, the electronic connections may be wired and/or wireless. In some embodiments, location determining means 118 may comprise of the communication means 102, where the communication means 102 may be a wireless communication means 102, which employ short range wireless protocol, such as, but not limited to, a radio frequency transceiver, a radio frequency receiver, and/or a radio frequency transmitter. In embodiments where the wireless communication means 102 is a radio frequency receiver, the radio frequency receiver may be any type of radio frequency receiver, including, but not limited to, a positioning system 106 receiver, such as a global positioning system receiver and a local positioning system receiver, such as a Wi-Fi positioning system receiver. In other embodiments, communication means 102 may employ wireless protocols like Blue Tooth, ZigBee, 802.11 series, or a wireless modem, such as, but not limited to, a global system for mobile communications (GSM) modem, or any other short range wireless protocol that is well known and used in the arts.

In some embodiments, at least one storage means 120 may be connected either electrically or mechanically to the at least one computer processor 108. In the case of electronic connections, the connections may be wired and/or wireless connections. Storage means 120 may comprise of a storage device and may include memory, such as, but is not limited to, read-only memory, such as CD-ROMs, DVDs, floppy disks, and the like, read and write memory, such as a hard drive, floppy disc, CD-RW, DVD-RW, solid state memory, such as solid state hard drives, flash memory, and the like, and random access memory. Storage means 120 may be used to store information, such as user preferences, including, but not limited to, points of interests, indoor locations, preloaded maps for the indoor structure 116, rated merchants, preferred merchants, and the like. The information may be retrieved from storage means 120 using the at least one processor 108. As such, the invention may be used for indoor large spaces, e.g. indoor shopping malls, convention centers, hospitals, hotels, theatres, museums, airports and even parking garages, or large outdoor areas such as theme parks, transportation systems, sports arenas, parking lots, communities and the service sector.

Computer's at least one processor 108′ may be any type of processor, such as a central processing unit (CPU), a microprocessor, a front end processor, a coprocessor, a single-core processor, a multi-core processor, as well as any known processor 108′ that's used in the arts. The at least one processor 108 is may be configured to determine the geographical location 110 of the mobile device 112, and determine the directions to or from the mobile device 112 to a desired location, e.g. an indoor structure 116 like a store. Such determinations may include triangulating the location of the mobile device 112 based on at least one positioning system signal 104 received by location determining means 118.

System 100 may also comprise of hardware and software components. Such software components include but are not limited to computer executable instructions 122 readable and executable by the computer's at least one processor 108, and operative to perform the varied system 100 functions and methods disclosed herein. Computer executable instructions 122 may be loaded directly on the computer's processor 108, or may be stored in computer's storage means 120, such as, but not limited to, computer readable media, such as, but not limited to, a hard drive, a solid state drive, a flash memory, random access memory, CD-ROM, CD-R, CD-RW, DVD-ROM, DVD-R, DVD-RW, and the like. Computer executable instructions 122 may be any type of computer executable instructions 122, which may be in the form of a computer program, the program being composed in any suitable programming language or source code, such as C++, C, JAVA, JavaScript, HTML, XML, and other programming languages. Computer executable instructions 122 executable by the at least one processor 108′ configured to perform any one or more of the following: determine geographical location 110 of a mobile device 112 based on the positioning system signal 104 by using the at least one processor 108 to triangulate the mobile device's geographical location 110 based on the at least one positioning system signal 104; generating directions to or from a structure 116 based on the geographical location 110 of the mobile device 112; and/or publishing the directions 114 to the mobile device 114.

In some embodiments, determining the geographical location 110 of the mobile device 112 includes determining the latitude and longitude coordinates of the current location of the mobile device 112, using the device's location determining means 118 receiving a signal 112, such as a location determination signal, from a positioning system 106, such as a global positioning system (GPS), or local positioning system, such as a Wi-Fi positioning system, which may originate from a satellite, or a ground based antenna.

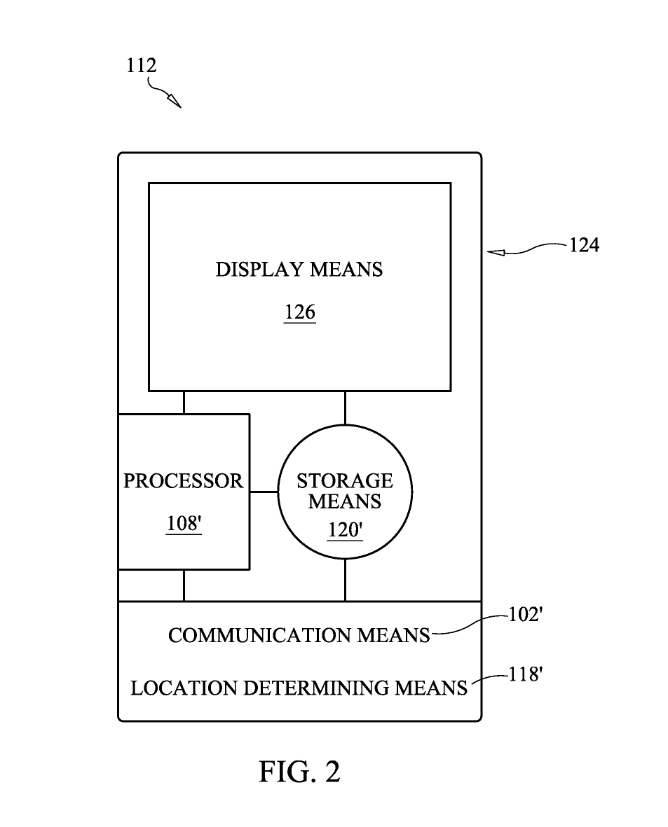

FIG. 2 is an exemplary embodiment of the mobile device 112 of the system 100 of the invention according to one embodiment. Mobile device 112 includes communication means 102′ equipped with location determining means 118′ either electrically or mechanically connected to its processor 108′. In the case of electronic connections, the electronic connections may be wired and/or wireless. In some embodiments, location determining means 118′ may comprise of communication means 102′, where the communication means 102′ may be a wireless communication means 102′ employing short range wireless protocol, such as, but not limited to, a radio frequency transceiver, a radio frequency receiver, and/or a radio frequency transmitter. In embodiments where the wireless communication means 102′ is a radio frequency receiver, the radio frequency receiver may be any type of radio frequency receiver, including, but not limited to, a positioning system 106 receiver, such as a global positioning system receiver and a local positioning system receiver, such as a Wi-Fi positioning system receiver. In other embodiments, the communication means 102′ may employ wireless protocols like Blue Tooth, ZigBee, 802.11 series, or a wireless modem, such as, but not limited to, a global system for mobile communications (GSM) modem, or any other short range wireless protocol that is well known and used in the arts.

In some embodiments, mobile device 112 may include at least one storage means 120′ either electrically or mechanically connected to mobile device's processor 108′. In the case of electronic connections, the electronic connections may be wired and/or wireless. Storage means 120′ may comprise of a storage device and may include memory, such as, but is not limited to, read-only memory, such as CD-ROMs, DVDs, floppy disks, and the like, read and write memory, such as a hard drive, floppy disc, CD-RW, DVD-RW, solid state memory, such as solid state hard drives, flash memory, and the like, and random access memory. Storage means 120′ may be used to store information, such as user preferences, including, but not limited to, at least one select point of interest targeted for an alert, categories of points of interests, preferred ratings for: gas stations, neighborhoods, merchant stores, maps, rated merchants, preferred merchants, and the like. The information may be retrieved from storage means 120′ using the mobile device's at least one processor 108′.

Mobile device's processor 108′ may be any type of processor, such as, but not limited to, a central processing unit (CPU), a microprocessor, a video processor, a front end processor, a coprocessor, a single-core processor, a multi-core processor, and the like. In some embodiments at least one processor 108′ is connected to the mobile device 112 where the mobile device's processor 108′ may be configured to determine the geographical position of the mobile device 112, and determine the proximity of the mobile device 112 to at least one point of interest 110 from a category of points of interests 110, 110′. Such calculations may include triangulating the location of mobile device 112 based on at least one positioning system signal 104 received by its location determining means 118′. In another embodiment, mobile device's processor 108′ may be wirelessly connected to location determining means 118′ so that the location determination may be performed remotely.

In some embodiments, determining geographical position of the mobile device 112 includes determining the latitude and longitude coordinates of the current geographical position of the mobile device 112, such as, the device's location determining means 118′ receiving a signal 112, such as a location determination signal, from a positioning system 106, such as a global positioning system (GPS), or local positioning system, such as a Wi-Fi positioning system, which may originate from a satellite, or a ground based antenna 118.

In some embodiments, positioned within the mobile device 112 is alarm means 124. Such alarm means 124 may include, but is not limited to, a vibrating alarm, a sounding or audible alarm, or a visual alarm, e.g. a flashing light or icon, which alerts the user that his or her mobile device 112 and by extension the user has reached the intended destination, e.g. the structure 116. In other embodiments, alarm means 124 may be included and/or incorporated in mobile device's processor 108′. Processor 108′ is configured to provide the at least one alert using the alarm means 124 when the geographical location 110 of the mobile device 112 is within a predefined radius from the at least one point of interest. The at least one alert 122 may be provided in any one or more of the following formats: audio, text or graphical on the device's display means 126.

Mobile device 112 includes display means 126 such as, but not limited to, an LCD screen, a monitor, an LED screen, and the like. In some embodiments, display means 126 is electronically connected to processor 108. In other embodiments, display means 126 is wirelessly connected to mobile device's processor 108′. In yet further embodiments, display means 126 may include a control means, such as, but not limited to, a keyboard, a mouse, a touch screen, a stylus, and the like. Display means 126 may display at the generated directions 114 in text and or graphical format, e.g. a map.

Mobile device's processor 108′ include computer executable instructions 122′ readable and executable by the mobile device's at least one processor 108′, and operative to perform the varied system 100 functions and methods disclosed herein. Computer executable instructions 122′ may be loaded directly on the mobile device's processor 108′, or may be stored in its storage means 120′, such as, but not limited to, computer readable media, such as, but not limited to, a hard drive, a solid state drive, a flash memory, random access memory, CD-ROM, CD-R, CD-RW, DVD-ROM, DVD-R, DVD-RW, and the like. Computer executable instructions 122′ may be any type of computer executable instructions 122, which may be in the form of a computer program, the program being composed in any suitable programming language or source code, such as C++, C, JAVA, JavaScript, HTML, XML, and other programming languages. Computer executable instructions 122′ executable by the at least one processor 108′ configured to perform any one or more of the following: control the communications with the computer processor 108 to determine geographical location 110 of a mobile device 112; generating directions to or from a structure 116 based on the geographical location 110 of the mobile device 112; and/or publishing the directions 114 in text, graphical or audio format. Mobile device's processor 108′ is also configured to generate and publish directions to at least one point of interest for a preselected alert on the display means 126 and/or to solicit instructions once the alert has been published, e.g. whether directions 114 are needed, format required for publishing the directions, messages, or other like instructions. In some embodiments, other information may be provided for the structure 116, e.g. telephone number, names of manager, times of operation, brief history of the point of interest 110, and the like.

### Methods

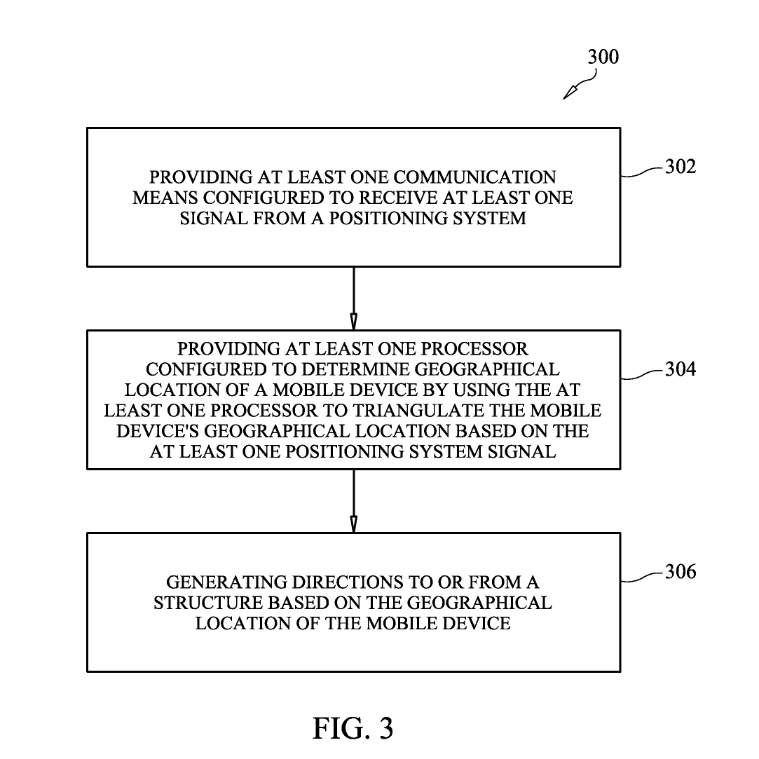

FIG. 3 shows a flowchart of an exemplary method 300 in accordance with one embodiment. Method 300 includes providing at least one communications means 102 configured to receive at least one signal 104 from a positioning system 106 (step 302). In some embodiments, the communication means 102 include location determining means 118 either electrically or mechanically connected to the computer processor 108 that controls the system 100 of the invention. In the case of electronic connections, the electronic connections may be wired and/or wireless. In some embodiments, location determining means 118 may comprise of communication means 102, where the communication means 102 may be a wireless communication means 102, which employ short range wireless protocol, such as, but not limited to, a radio frequency transceiver, a radio frequency receiver, and/or a radio frequency transmitter. In embodiments where the wireless communication means 102 is a radio frequency receiver, the radio frequency receiver may be any type of radio frequency receiver, including, but not limited to, a positioning system 106 receiver, such as a global positioning system receiver and a local positioning system receiver, such as a Wi-Fi positioning system receiver. In other embodiments, communication means 102 may employ wireless protocols like Blue Tooth, ZigBee, 802.11 series, or a wireless modem, such as, but not limited to, a global system for mobile communications (GSM) modem, or any other short range wireless protocol that is well known and used in the arts.

Computer's at least one processor 108′ may be any type of processor, such as a central processing unit (CPU), a microprocessor, a front end processor, a coprocessor, a single-core processor, a multi-core processor, as well as any known processor 108′ that's used in the arts. The at least one processor 108 is may be configured to determine the geographical location 110 of the mobile device 112, and determine the directions to or from the mobile device 112 to a desired location, e.g. an indoor structure 116 like a store. Such determinations may include triangulating the location of the mobile device 112 based on at least one positioning system signal 104 received by location determining means 118.

In some embodiments, at least one storage means 120 may be connected either electrically or mechanically to the at least one processor 108. In the case of electronic connections, the electronic connections may be wired and/or wireless connections. Storage means 120 may comprise of a storage device and may include memory, such as, but is not limited to, read-only memory, such as CD-ROMs, DVDs, floppy disks, and the like, read and write memory, such as a hard drive, floppy disc, CD-RW, DVD-RW, solid state memory, such as solid state hard drives, flash memory, and the like, and random access memory. Storage means 120 may be used to store information, such as user preferences, including, but not limited to, points of interests, indoor locations, maps for the indoor structure, rated merchants, preferred merchants, and the like. The information may be retrieved from storage means 120 using the at least one processor 108.

Computer's at least one processor 108′ may be any type of processor, such as a central processing unit (CPU), a microprocessor, a front end processor, a coprocessor, a single-core processor, a multi-core processor, as well as any known processor 108′ that's used in the arts.

Method 300 further comprises of providing the at least one processor 108 configured to determine geographical location 110 of a mobile device 112 to triangulate the mobile device's geographical location 110 based on the at least one positioning system 106 signal (step 304) and generating directions 114 to or from a structure 116 based on the geographical location 110 of the mobile device 112 (step 306). In some embodiments, at least one processor 108 is wirelessly connected to the mobile device 112 where the computer processor 108 is configured to determine the geographical location 110 of the mobile device 112, and determine the directions to or from the mobile device 112 to a desired location, e.g. an indoor structure 116 like a store. Such determinations may include triangulating the location of the mobile device 112 based on at least one positioning system signal 104 received by location determining means 118. The computer processor 108 controls its communication means 102 which communicates with the mobile device's communication means 102′ such that the any information required to perform the triangulation of the mobile device's geographical location 110 can be exchanged

In some embodiments, the communications means 102, 102′ may be a wireless communications means, such as, but not limited to, a radio frequency transceiver, a radio frequency receiver, and/or a radio frequency transmitter. In embodiments where the wireless communications means 102, 102′ is a radio frequency receiver, the radio frequency receiver may be any type of radio frequency receiver, including, but not limited to, a positioning system receiver, such as a global positioning system receiver and a local positioning system receiver, such as a wi-fi positioning system receiver. In other embodiments, the communications means 102, 102′ may be a wireless modem, such as, but not limited to, a global system for mobile communications (GSM) modem. In some embodiments, the communications means 102, 102′ may receive a signal from a positioning system 106, such as a global positioning system or local positioning system, which may originate from a satellite, or a ground based antenna (not shown). The communications means is configured to receive the at least one signal 104 from a positioning system 106 over a wireless area network.

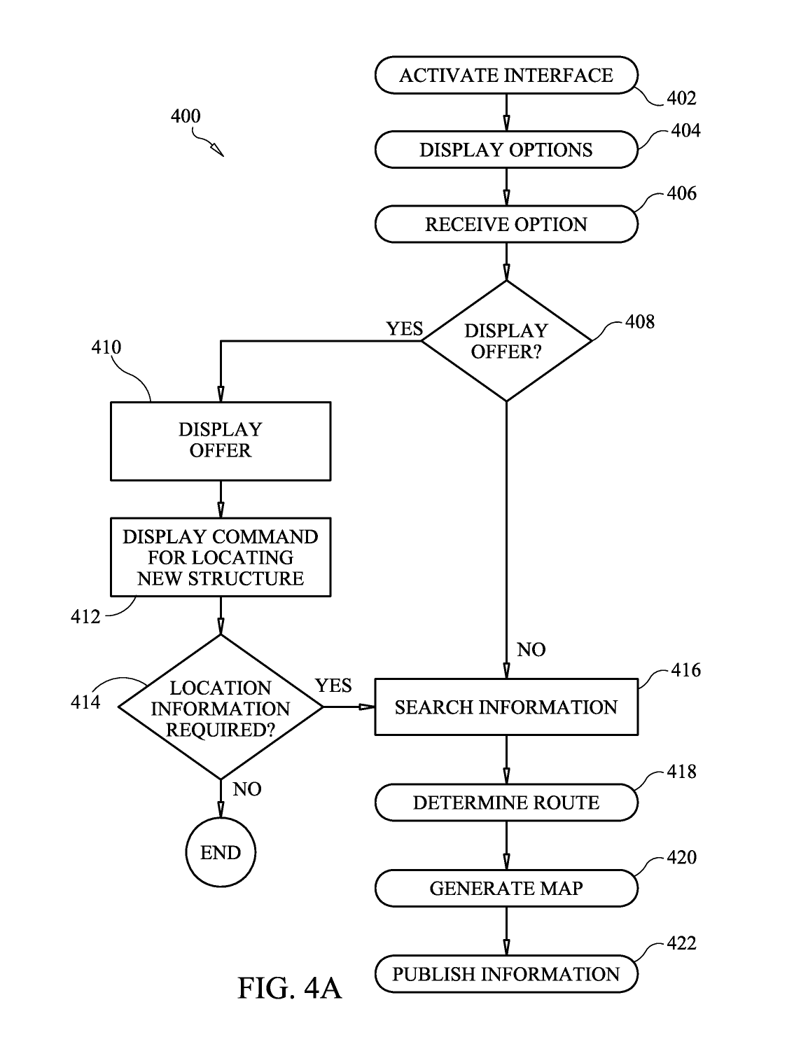

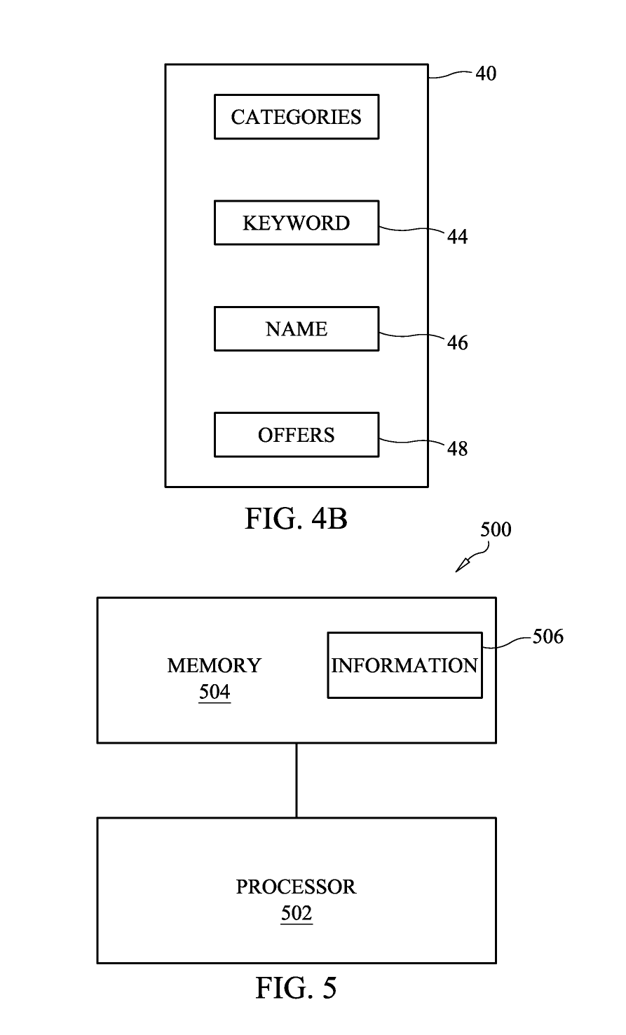

FIGS. 4A & 4B show exemplary block diagrams depicting an alternate method in accordance with various embodiments. A user may use the system 100 and method 400 by accessing the system (step 402) over the Internet, from which the system 100 may display options 40 (step 404), from which the user may select how the system will be used.

As shown in FIG. 4B options 40 may include but not limited to making selections by: categories 42, keyword 44 searches, names 46, and offers 48 from participating merchants. Categories 42 may include but is not limited to accessories, jewelry stores, electronic stores, etc. as well as any known categories 42 that are used in the arts. Keyword 44 searches may include but not limited particular keywords that may be inclusive of categories 42 as well as brand names, store names, etc. Some users will prefer to locate a particular store by name 46, and as such will choose to find the intended destination structure 116 preferably by providing the name 46 as their preferred option 40.

The system 100 and method 400 also includes providing rebates, coupons, discounts, special offers to users from participating vendors such that users may experience the most favorable pricing as a participant of this system 100 and method 400. In one embodiment, the system 100 may provide directions 114 for a first selected indoor structure 116 and based on the keyword 44, category 42 or name 46 previously provided to the system 100 generate directions 114 for the second and third structure 116, 116′ that may be related to that option 40. In this manner, if a user is unable to locate an item in one store, the user may use the second structure 116 to find an alternate store that may have the item for sale.

Referring back to FIG. 4A, once the user selects the option 40, the system 100 receives the option 40 (step 406) and if it pertains to categories 42, keyword 44, or name 46 selection system will proceed directly to step 316. However, if the user selected the option 40 to display offers 48, 48′ (step 408), then the offer will be displayed (step 410). User will have the option to request a new structure 116 for which he/she will need directions 114, in which case the system 100 will display command for locating new structure (step 412). If the user does not want any additional location information (step 314) then user can effectively opt out of the system 1000. However, if user requested directions 114 (step 414) the system 1000 searches its storage means 120 (step 316) and generates directions 114 (step 420) and publishes the information to the mobile device 112 where it may be displayed in graphics or text and or broadcasted in audio. (step 422).

While the invention has been described in connection with specific embodiments and applications, the inventor does not intend to restrict the description to the examples shown. Persons skilled in the art will recognize that the above system 100 and methods 12, 12′ may be modified or changed without departing from the general scope of the present description, the intention of the inventor being to include all such modifications and alterations in so far as they come within the scope of the appended claims or the equivalents thereof. It will be understood that each of the elements described above, or two or more together may also find a useful application in other types of methods 12, 12′ differing from the type described above.

In yet another embodiment, apparatus 100 further comprises computer executable instructions readable by the processor and operative to determine the location of apparatus 100 by calculating the location of apparatus 100, such as by triangulating the location of apparatus 100 based on at least one positioning system signal received by the communications means described above. The computer executable instructions may be any type of computer executable instructions, which may be in the form of a computer program, the program being composed in any suitable programming language or source code, such as C++, C, JAVA, JavaScript, HTML, XML, and other programming languages.

### Hardware and Operating Environment

This section provides an overview of example hardware and the operating environments in conjunction with which embodiments of the inventive subject matter can be implemented.

A software program may be launched from a computer readable medium in a computer-based system 100 to execute the functions defined in the software program. Various programming languages may be employed to create software programs designed to implement and perform the methods 200, 300, disclosed herein. The programs may be structured in an object-orientated format using an object-oriented language such as Java or C++. Alternatively the programs may be structured in a procedure-oriented format using a procedural language, such as assembly or C. The software components may communicate using a number of mechanisms, such as application program interfaces, or inter-process communication techniques, including remote procedure calls. The teachings of various embodiments are not limited to any particular programming language or environment. Thus, other embodiments may be realized, as discussed regarding FIG. 4 below.

FIG. 5 is a block diagram representing an apparatus 100 according to various embodiments. Such embodiments may comprise a computer, a memory system, a magnetic or optical disk, some other storage device, or any type of electronic device or system. The apparatus 500 may include one or more processor(s) 502 coupled to a machine-accessible medium such as a memory 504 (e.g., a memory including electrical, optical, or electromagnetic elements). The medium may contain associated information 506 (e.g., computer program instructions, data, or both) which, when accessed, results in a machine (e.g., the processor(s) 502) performing the activities previously described herein.

The principles of the present disclosure may be applied to all types of computers, systems, and the like, include desktop computers, servers, notebook computers, personal digital assistants, microcomputers, and the like. However, the present disclosure may not be limited to the personal computer.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed is:

1. A method comprising:
a. providing at least one communications means configured to receive at least one signal from a positioning system;
b. providing at least one processor configured to determine geographical location of a mobile device by using the at least one processor to triangulate the mobile device's geographical location based on the at least one positioning system signal; and
c. generating directions to or from a structure based on the geographical location of the mobile device.

2. The method of claim 1, further comprising publishing the directions to the mobile device.

3. The method of claim 2, wherein the directions may be published in any one or more of the following formats: audio, text or graphical.

4. The method of claim 1, wherein the communications means is a radio frequency transceiver.

5. The method of claim 1, wherein the communications means is configured to communicate wirelessly.

6. The method of claim 1, wherein the communications means is configured to receive the at least one signal from a positioning system over a wireless area network.

7. The method of claim 1, wherein the mobile device includes at least one positioning system receiver.

8. The method of claim 6, wherein the positioning system receiver includes, but is not limited to: a positioning system receiver, such as a global positioning system receiver and a local positioning system receiver, such as a wi-fi positioning system receiver.

9. A system comprising:
a. at least one communications means configured to receive at least one signal from a positioning system; and
b. at least one processor configured to determine geographical location of a mobile device based on the positioning system signal by using the at least one processor to triangulate the mobile device's geographical location based on the at least one positioning system signal and wherein the at least one processor is configured for generating directions to or from a structure based on the geographical location of the mobile device.

10. The system of claim 9, wherein the at least one processor is further configured for publishing the directions to the mobile device.

11. The system of claim 9, wherein the directions may be published in any one or more of the following formats: audio, text or graphical.

12. The system of claim 9, wherein the communications means is a radio frequency transceiver.

13. The system of claim 9, wherein the communications means is configured to communicate wirelessly.

14. The system of claim 9, wherein the communications means is configured to receive the at least one signal from a positioning system over a wireless area network.

15. The system of claim 9, wherein the mobile device comprises at least one positioning system receiver.

16. The system of claim 14, wherein the positioning system receiver includes, but is not limited to: a positioning system receiver, such as a global positioning system receiver and a local positioning system receiver, such as a wi-fi positioning system receiver.
